(19) United States
(12) Patent Application Publication
(10) Pub. No.: US 2025/0242285 A1
(43) Pub. Date: Jul. 31, 2025

(54) Air Filtration Housing

(71) Applicant: WAL Fuel Systems USA Inc., Livonia, MI (US)

(72) Inventors: Xianhong Pang, Livonia, MI (US); Xiaoqin Zhang, Livonia, MI (US); Xiankai Song, Livonia, MI (US)

(21) Appl. No.: 18/425,730

(22) Filed: Jan. 29, 2024

(51) Int. Cl. B01D 46/00; B01D 46/24; B01D 46/54; B60L 50/64; H01M 8/0662

(52) U.S. Cl. CPC B01D 46/0045; B01D 46/24; B01D 46/543; H01M 8/0687; B60L 50/64; H01M 2250/20

(57) ABSTRACT

An air filter housing for a vehicle includes a body having a wall defining a cavity configured to retain an air filter therein. The air filter housing includes an inlet defining an inlet passage in fluid communication with the cavity and configured to convey air into the cavity. The inlet passage extends along an entrance axis through the wall into the cavity, with the entrance axis transverse to the wall. The air filter housing includes an outlet defining an outlet passage in fluid communication with the cavity and configured to convey the air out of the cavity. The air filter housing includes a baffle disposed within the cavity and positioned adjacent the inlet passage. The baffle comprises teeth arranged in a row and positioned at least partially across the outlet passage to uniformly direct the air flowing from the inlet passage into the cavity.

### TECHNICAL FIELD

This disclosure relates generally to the field of air filtration housings for a vehicle.

### BACKGROUND

Many industries utilize air filtration systems to clean air. One particular application is a fuel cell system, which is an electrochemical device that combines hydrogen fuel with oxygen to produce electricity. Ambient air may flow to a fuel cell system as a source of oxygen. However, the air must be cleaned to prevent damage to sensitive components of the fuel cell system and thus ensure a chemical reaction occurs that produces the electricity. The air filtration system may include an air filtration housing defining a cavity for receiving the air and an air filter that is permeable to the air and configured to remove debris from the air.

### SUMMARY

One aspect of the disclosure is an air filter housing for a vehicle. The air filter housing includes a body having a wall defining a cavity configured to retain an air filter therein. The air filter housing includes an inlet defining an inlet passage in fluid communication with the cavity and configured to convey air into the cavity. The inlet passage extends along an entrance axis through the wall into the cavity, with the entrance axis transverse to the wall. The air filter housing includes an outlet defining an outlet passage in fluid communication with the cavity and configured to convey the air out of the cavity. The air filter housing includes a baffle disposed within the cavity and positioned adjacent the inlet passage. The baffle comprises teeth arranged in a row and positioned at least partially across the outlet passage to uniformly direct the air flowing from the inlet passage into the cavity.

In some implementations of the air filter housing, the entrance axis intersects the wall and defines an angle therebetween, with the angle being between 50 degrees and 70 degrees.

In some implementations of the air filter housing, the angle is between 55 degrees and 65 degrees.

In some implementations of the air filter housing, each of the teeth has a generally rectangular prismatic configuration and are spaced from one another within the row.

In some implementations of the air filter housing, the baffle comprises a frame extending at least partially across the inlet passage, with the teeth extending from the frame.

In some implementations of the air filter housing, the frame is positioned between the inlet passage and the outlet passage and is configured to deflect the air from the inlet passage through the teeth and into the cavity away from the outlet passage.

In some implementations of the air filter housing, the outlet passage extends along an exit axis through the wall into the cavity, with the exit axis transverse to the entrance axis.

In some implementations of the air filter housing, the wall of the body has a cylindrical configuration defining a first end portion and a second end portion spaced from one another along the exit axis and a central portion extending between the first end portion and the second end portion and around the exit axis.

In some implementations of the air filter housing, the inlet is disposed on the central portion of the wall and the outlet is disposed on the first end portion of the wall.

In some implementations of the air filter housing, the body has a midline halfway between the first end portion and the second end portion, with the inlet disposed between the first end portion and the midline.

In some implementations of the air filter housing, the baffle is connected to first end portion and extends from the first end portion toward the second end portion.

In some implementations of the air filter housing, the baffle extends at least partially around the exit axis.

In some implementations of the air filter housing, the air filter housing includes a second baffle connected to the second end portion of the wall and extending from the second end portion toward the first end portion.

In some implementations of the air filter housing, at least a portion of the inlet is curved.

Another aspect of the disclosure is an air filter housing for a vehicle. The air filter housing includes a body having a wall defining a cavity configured to retain an air filter therein, with the wall having a cylindrical configuration defining a first end portion and a second end portion spaced from one another along an exit axis and a central portion extending between the first end portion and the second end portion and around the exit axis. The air filter housing includes an inlet defining an inlet passage in fluid communication with the cavity and configured to convey air into the cavity. The inlet passage extends along an entrance axis through the central portion of the wall into the cavity, with the entrance axis transverse to the wall. The air filter housing includes an outlet defining an outlet passage in fluid communication with the cavity and configured to convey the air out of the cavity. The outlet passage extends along the exit axis through the first end portion of the wall into the cavity, with the exit axis transverse to the entrance axis. The air filter housing includes a baffle disposed within the cavity and connected to the first end portion. The baffle extends from the first end portion toward the second end portion and is positioned adjacent the inlet passage. The baffle comprises teeth arranged in a row and positioned at least partially across the outlet passage to uniformly direct the air flowing from the inlet passage into the cavity. The entrance axis intersects the wall and defines an angle therebetween, with the angle being between 50 degrees and 70 degrees.

Another aspect of the disclosure is an air filtration system for a vehicle. The air filtration system includes an air filter housing including a body having a wall defining a cavity. The air filter housing includes an inlet defining an inlet passage in fluid communication with the cavity and configured to convey air into the cavity. The inlet passage extends along an entrance axis through the wall into the cavity, with the entrance axis transverse to the wall. The air filter housing includes an outlet defining an outlet passage in fluid communication with the cavity and configured to convey the air out of the cavity. The air filter housing includes a baffle disposed within the cavity and positioned adjacent the inlet passage. The baffle comprises teeth arranged in a row and positioned at least partially across the outlet passage to uniformly direct the air flowing from the inlet passage into the cavity. The air filtration system further includes an air filter disposed within the cavity and comprising a membrane positioned between the inlet and the outlet for removing debris from the air.

In some implementations of the air filtration system, the outlet passage extends along an exit axis through the wall into the cavity, with the exit axis transverse to the entrance axis.

In some implementations of the air filtration system, the wall of the body has a cylindrical configuration defining a first end portion and a second end portion spaced from one another along the exit axis and a central portion extending between the first end portion and the second end portion and around the exit axis.

In some implementations of the air filtration system, the membrane surrounds the exit axis such that the air filter has a cylindrical configuration corresponding to the body, with the membrane at least partially defining a bore that extends through the air filter along the exit axis.

In some implementations of the air filtration system, the membrane of the air filter is spaced from the central portion of the wall and divides the cavity into a first chamber disposed between the membrane and the central portion and a second chamber corresponding to the bore, with the air configured to permeate through the membrane from the first chamber to the second chamber.

### BRIEF DESCRIPTION OF THE DRAWINGS

The disclosure is best understood from the following detailed description when read in conjunction with the accompanying drawings. It is emphasized that, according to common practice, the various features of the drawings may be not to-scale. On the contrary, the dimensions of the various features may be arbitrarily expanded or reduced for clarity.

FIG. 1 is a perspective view illustration of one example of an air filtration system.

FIG. 2 is a partial cross-sectional side view illustration of the air filtration system of FIG. 1.

FIG. 3 a perspective view illustration of the air filtration system of FIG. 1.

FIG. 4 is a perspective view illustration of another example of the air filtration system.

FIG. 5 is a side view illustration of the air filtration system of FIG. 4.

### DETAILED DESCRIPTION

This disclosure is directed to air filtration systems for use in a vehicle. One particular application in a vehicle is a fuel cell system, which is an electrochemical device that combines hydrogen fuel with oxygen to produce electricity that powers (among other things) electric motors which propel the vehicle. The quality of the hydrogen and the oxygen must be carefully regulated to ensure a complete chemical reaction occurs that produces the electricity. Accordingly, air filtration systems remove particulates from ambient air, which is utilized as a source of the oxygen.

Traditional air filtration systems utilize an air filtration housing comprising a body having a cylindrical configuration. The air filtration housing includes an outlet disposed at one of a pair of ends of the body. The air filtration housing further includes an inlet disposed along a side that extends between the pair of ends. The outlet and inlet are positioned orthogonal to one another. The air filtration system further includes an air filter having a cylindrical configuration and disposed within the body. Air that flows into the body from the inlet passes through the air filter toward the outlet, with the air filter configured to remove debris from the air. Because of pressure differential between the inlet and the outlet (i.e., the inlet being higher pressure than the outlet), the air has a tendency to flow generally in a straight line between the inlet and the outlet. As such, only a portion of the air filter (aligned between the inlet and the outlet) is generally utilized to remove the debris from the air, which inhibits the performance of the air filter.

The air filtration system described herein includes an inlet that is positioned non-orthogonal to the body. More specifically, the inlet is angled to flow the air toward the end of the body that opposes the outlet. The air filtration housing further includes a baffle adjacent the inlet that further directs the air opposite the outlet. The baffle further includes teeth that direct the air into uniform flow. Accordingly, the positioning of the inlet and the configuration of the baffle produce uniform flow toward the end of the body that opposes the outlet, which evenly distributes the air along the air filter to utilize the air filter in its entirety for cleaning the air. Furthermore, this configuration of the air filtration housing also reduces pressure drop between the inlet and the body that may occur due to the intrusion of the baffle into the flow field.

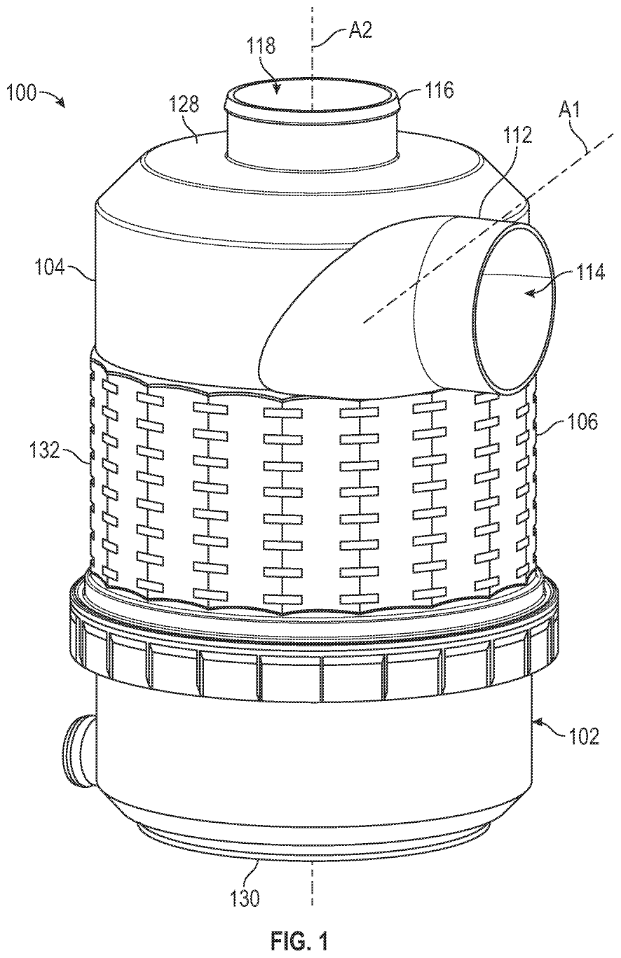

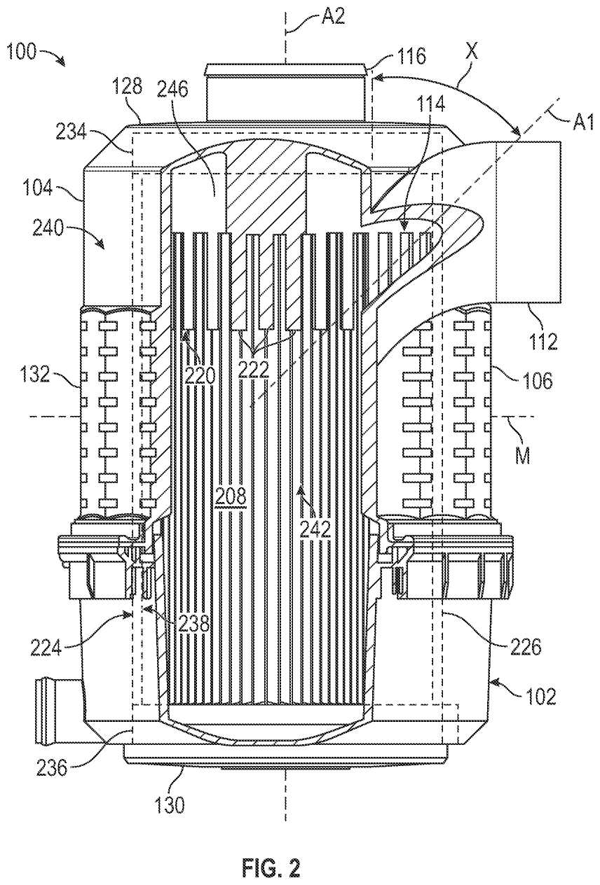

FIG. 1 is a perspective view illustration of an air filtration system 100 for a vehicle. The vehicle may be a road-going vehicle that is supported by wheels and is able to travel freely upon roadways and other surfaces. The air filtration system 100 removes debris from air, which is utilized as a source of oxygen for a fuel cell system. The air filtration system 100 includes an air filter housing 102. The air filter housing 102 includes a body 104 having a wall 106 defining a cavity 208, as shown in FIG. 2. The body 104 may comprise a polymer, a metal, or any other suitable material. In the example shown in FIG. 1, the body 104 is comprised of two sections, with the sections forming the cavity 208 when assembled to one another. Moreover, when the sections are disassembled the cavity 208 may be accessed. It is to be appreciated that the body 104 may be formed from any number of sections.

The air filter housing 102 includes an inlet 112 defining an inlet passage 114 in fluid communication with the cavity 208 and configured to convey the air into the cavity 208. The inlet passage 114 extends along an entrance axis A1 through the wall 106 into the cavity 208, with the entrance axis A1 transverse to the wall 106. The air filter housing 102 further includes an outlet 116 defining an outlet passage 118 in fluid communication with the cavity 208 and configured to convey the air out of the cavity 208 and to the fuel cell system.

FIG. 2 is a partial cross-sectional side view illustration of the air filtration system 100, showing the cavity 208. The air filter housing 102 further includes a baffle 220 disposed within the cavity 208 and positioned adjacent the inlet passage 114. The baffle 220 comprises teeth 222 arranged in a row and positioned at least partially across the outlet passage 118 to uniformly direct the air flowing from the inlet passage 114 into the cavity 208.

The air filtration system 100 further includes an air filter 224 disposed within the cavity 208 and comprising a membrane 226 positioned between the inlet 112 and the outlet 116 for removing debris from the air (e.g., dirt, dust, etc.). The membrane 226 may comprise cellulose, carbon, fiberglass, etc., which has openings that are large enough to allow air to permeate therethrough while small enough to prevent debris from passing therethrough. As such, the air that enters the cavity 208 from the inlet passage 114 passes through the membrane 226 of the air filter 224 and out of the outlet passage 118, with the debris being removed from the air as the air passes through the membrane 226. Accordingly, the air filtration system 100 receives air from outside of the vehicle through the inlet passage 114 into the cavity 208 of the housing. The air passes through the membrane 226 where the debris is removed from the air by the membrane 226 of the air filter 224, thereby cleaning the air. After passing through the air filter 224, the air passes from cavity 208, through the outlet passage 118, to the fuel cell system where the air may be utilized to produce electricity.

As shown in FIGS. 1 and 2, the outlet passage 118 extends along an exit axis A2 through the wall 106 into the cavity 208. More specifically, the wall 106 of the body 104 has a cylindrical configuration defining a first end portion 128 and a second end portion 130 spaced from one another along the exit axis A2 and a central portion 132 extending between the first end portion 128 and the second end portion 130 and around the exit axis A2. The inlet 112 is disposed on the central portion 132 of the wall 106 and the outlet 116 is disposed on the first end portion 128 of the wall 106. Therefore, the inlet passage 114 extends through the central portion 132 of the wall 106 and the outlet passage 118 extends through the first end portion 128 of the wall 106. As such, the exit axis A2 is transverse to the entrance axis A1.

The air filter 224 has a first frame member 234 having a circular configuration that surrounds the exit axis A2 and engages the first end portion 128 of the wall 106. The air filter 224 also has a second frame member 236 having a circular configuration that surrounds the exit axis A2 and engages the second end portion 130 of the wall 106. The membrane 226 of the air filter 224 extends between the first frame member 234 and the second frame member 236. Furthermore, the membrane 226 surrounds the exit axis A2 such that the air filter 224 has a cylindrical configuration corresponding to the body 104, with the membrane 226 at least partially defining a bore 238 that extends through the air filter 224 along the exit axis A2. The membrane 226 of the air filter 224 is spaced from the central portion 132 of the wall 106 and divides the cavity 208 into a first chamber 240 disposed between the membrane 226 and the central portion 132 and a second chamber 242 corresponding to the bore 238. The engagement of the first frame member 234 with the first end portion 128 and the second frame member 236 with the second end portion 130 fluidly separates the first chamber 240 from the second chamber 242, but for the permeability of the membrane 226 to air. As such, the air is configured to permeate through the membrane 226 from the first chamber 240 to the second chamber 242.

As shown in FIG. 2, the body 104 has a midline M halfway between the first end portion 128 and the second end portion 130. The inlet 112 is disposed between the first end portion 128 and the midline M. However, the inlet 112 may be positioned at the midline M or between the second end portion 130 and the midline M. Moreover, it is to be appreciated that the inlet 112 may be positioned on any suitable portion of the wall 106 of the body 104.

The baffle 220 is connected to first end portion 128 and extends from the first end portion 128 toward the second end portion 130. More specifically, the baffle 220 comprises a frame 246 that is connected to the first end portion 128. The baffle 220 is positioned in the first chamber 240 of the cavity 208 such that the air entering the cavity 208 from the inlet passage 114 hits the baffle 220 and directs the flow of the air. The frame 246 extends at least partially across the inlet passage 114, with the teeth 222 extending from the frame 246. More specifically, the teeth 222 extend from the frame 246 toward the second end portion 130. In the example shown in FIG. 2, the frame 246 extends across approximately half of the inlet passage 114 with the teeth 222 extending across the remainder of the inlet passage 114.

In the example shown in FIG. 2, each of the teeth 222 has a generally rectangular prismatic configuration and are spaced from one another within the row. As such, the air that contacts the teeth 222 is directed through spacing between the teeth 222 in parallel paths that form substantially laminar flow into the air filter 224. It is to be appreciated that the teeth 222 may have any suitable configuration for directing the flow of the air.

Furthermore, since the outlet passage 118 is disposed on the first end portion 128 and the inlet passage 114 is disposed on the central portion 132, the frame 246 (extending from the first end portion 128) is positioned between the inlet passage 114 and the outlet passage 118. Therefore, the frame 246 is configured to deflect the air from the inlet passage 114 through the teeth 222 and into the cavity 208 away from the outlet passage 118. More specifically, the air entering the cavity 208 from the inlet passage 114 hits the frame 246 and must flow toward the second end portion 130 to move around the frame 246. As such, the air passes along more of the air filter 224, in comparison to a direct path between the inlet passage 114 and the outlet passage 118 if the baffle 220 was not disposed in the cavity 208. The air that is directed toward the second end portion 130 may also pass through the teeth 222, further improving the uniformity of the flow and facilitating efficient permeation of the air through the membrane 226 of the air filter 224.

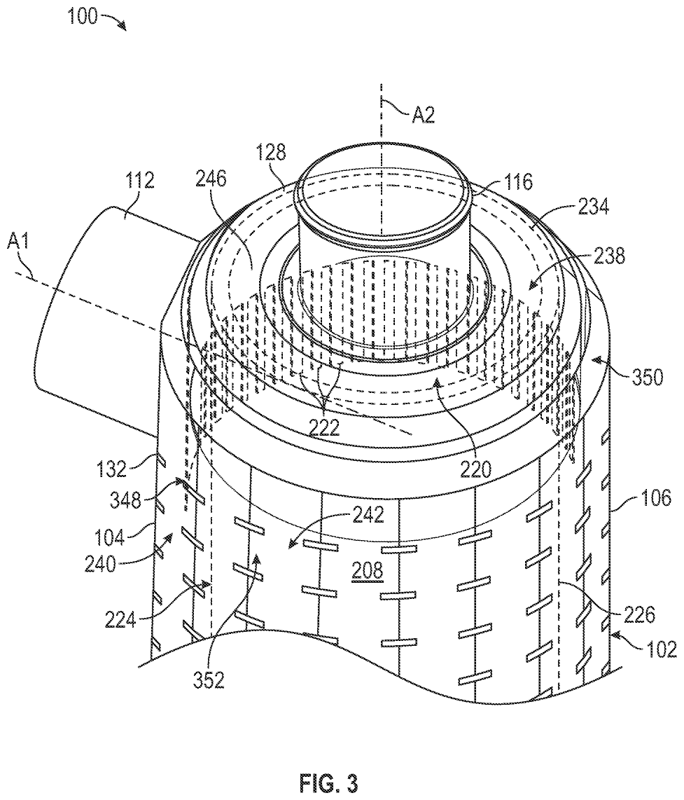

FIG. 3 a perspective view illustration of the air filtration system 100 showing the baffle 220 extending at least partially around the exit axis A2. More specifically, the baffle 220 extends around the exit axis A2 from a first end 348 to a second end 350. The first end 348 is positioned proximate the inlet passage 114, with the baffle 220 extending from the first end 348 across the inlet passage 114 and approximately halfway around the axis to the second end 350. Accordingly, the first end 348 and the second end 350 define a gap 352 therebetween. When the air enters the cavity 208 and is directed by the baffle 220, a portion of the air will flow around the exit axis A2 along the baffle 220 due to air pressure in the cavity 208 between the baffle 220 and the second end portion 130. The air moves along the baffle 220 to the gap 352 where the gap 352 allows the air to move toward the air filter 224 proximate the first end portion 128. As such, the gap 352 ensures that the membrane 226 is utilized in its entirety to clean the air that enters the cavity 208.

As described above, the inlet passage 114 extends along the entrance axis A1 through the central portion 132 of the wall 106 into the cavity 208. The entrance axis A1 intersects the wall 106 and defines an angle X therebetween. In the example shown in FIG. 2, the entrance axis A1 intersects the central portion 132 of the wall 106, which extends parallel to the exit axis A2. Therefore, in this example the angle X may also be defined between the entrance axis A1 and the exit axis A2. In one example, the angle X is between 50 degrees and 70 degrees. In another example, the angle X is between 55 degrees and 65 degrees. In the example shown in FIG. 2, the angle X is approximately 60 degrees. The angle X positions the inlet passage 114 such that the inlet passage 114 partially faces the second end portion 130 of the wall 106. Therefore, the angle X of the inlet passage 114, in conjunction with the baffle 220, directs the air toward the second end portion 130 which reduces pressure drop between the inlet passage 114 and the cavity 208. The pressure drop can occur due to the intrusion of the baffle 220 into the flow field. Furthermore, directing the air toward the second end portion 130 evenly distributes the air along the air filter 224 to utilize the air filter 224 in its entirety for cleaning the air. It is to be appreciated that the angle X may be adjusted and optimized to produce desired flow characteristics of the air. Moreover, the angle X may be adjusted to any suitable position between or equal to zero degrees and 90 degrees.

At least a portion of the inlet 112 (moreover, the inlet passage 114) is curved. More specifically, in the example shown in FIG. 2, the inlet 112 is curved such that the inlet 112 truncates away from the body 104 in a position that is orthogonal to the wall 106 and the outlet 116. In doing so, the air filtration housing is configured for assembly within the vehicle to components that are commonly positioned orthogonal to one another (e.g., an inlet tube connected to the inlet 112 of the air filtration housing and an outlet tube connected to the outlet 116 of the air filtration housing). It is to be appreciated that the inlet 112 may have a linear configuration or any combination of linear sections and/or curved sections.

As described above, the entrance axis A1 intersects the wall 106 and defines the angle X therebetween. As shown in FIG. 2, the inlet 112 and the inlet passage 114 are curved. More specifically the inlet 112 and the inlet passage 114 are curved where the inlet passage 114 intersects the wall 106. Accordingly, the entrance axis A1 is defined as the tangent of the curve where the inlet passage 114 intersects the wall 106, which corresponds to the direction of flow of the air when the air leaves the inlet passage 114 and enters the cavity 208.

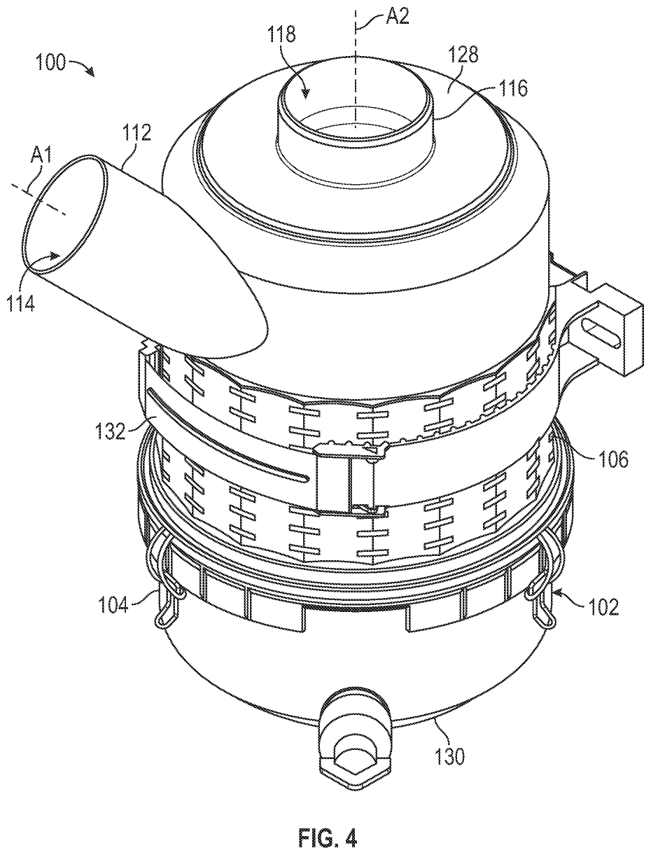

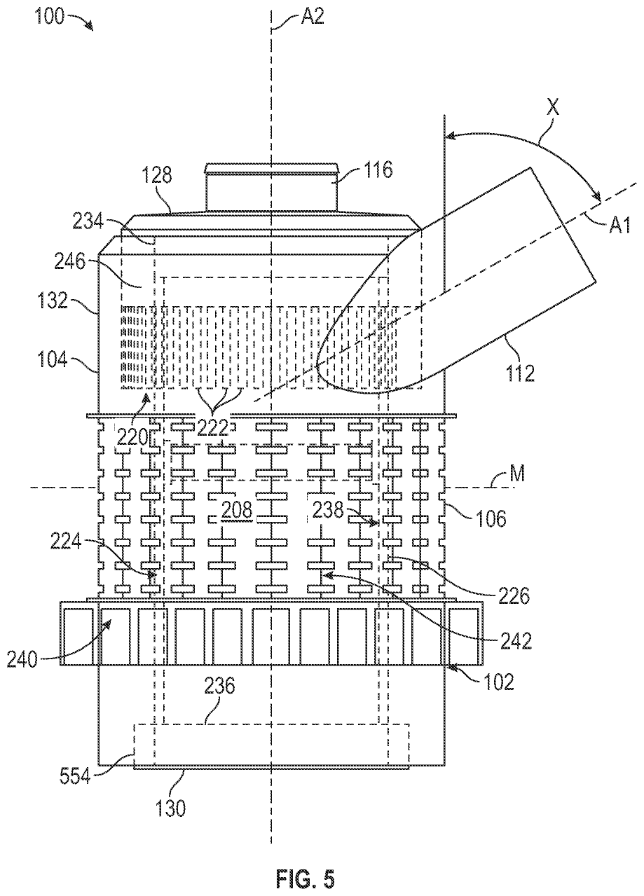

FIGS. 4 and 5 show an example implementation of the air filtration system 100 in which the air filtration housing further includes a second baffle 554 connected to the second end portion 130 of the wall 106 and extending from the second end portion 130 toward the first end portion 128. The second baffle 554 extends in circular configuration around the exit axis A2. The air filter 224 is disposed within and engages the second baffle 554. As such, the second baffle 554 retains the air filter 224 within the cavity 208. Furthermore, the air filter housing 102 is positioned within the vehicle in a substantially vertical orientation, with the first end portion 128 of the body 104 disposed above the second end portion 130. As such, debris within the air in the first chamber 240 of the cavity 208 may settle (due to gravity) at the second end portion 130 of the body 104. The second baffle 554 further collects the debris that settles out of the air.

The example in FIGS. 4 and 5 also differs from the example shown in FIGS. 1-3 in the shape of the inlet 112 and the inlet passage 114. More specifically, each of the inlet 112 and the inlet passage 114 shown in FIGS. 4 and 5 has a linear configuration that is positioned along the angle X. As described above, the inlet 112 and the inlet passage 114 may have any suitable configuration for delivering the air to the cavity 208 of the body 104.

While the disclosure has been described in connection with certain examples, it is to be understood that the disclosure is not to be limited to the disclosed examples but, on the contrary, is intended to cover various modifications and equivalent arrangements included within the scope of the appended claims, which scope is to be accorded the broadest interpretation so as to encompass all such modifications and equivalent structures as is permitted under the law.

It should be noted in the examples of the present disclosure that, in the description of the present disclosure, orientations or positional relationships indicated by the terms “radial,” “axial,” “upper,” “lower,” “inner,” “outer,” “front,” “rear,” “left,” “right,” “center” and the like orientations or positional relationships shown in the drawings, which are only for convenience of description and do not indicate or imply a device or elements need to have a particular orientation, be constructed, and be operated in a particular orientation and are therefore not to be construed as limitations to the present disclosure.

In addition, it should be noted in the examples of the present disclosure that, in the description of the present disclosure, unless otherwise expressly specified and limited, the terms “set,” “mounted,” “connected” and “coupled” should be understood in a broad sense. For example, it may be a fixed connection, a detachable connection, or an integral connection; it may be a mechanical connection; it may be a direct connection, or an indirect connection through an intermediate medium, and it may be internal communication between two elements.

What is claimed is:

1. An air filter housing for a vehicle, the air filter housing comprising:
a body having a wall defining a cavity configured to retain an air filter therein;
an inlet defining an inlet passage in fluid communication with the cavity and configured to convey air into the cavity, wherein the inlet passage extends along an entrance axis through the wall into the cavity, with the entrance axis transverse to the wall;
an outlet defining an outlet passage in fluid communication with the cavity and configured to convey the air out of the cavity; and
a baffle disposed within the cavity and positioned adjacent the inlet passage, wherein the baffle comprises teeth arranged in a row and positioned at least partially across the outlet passage to uniformly direct the air flowing from the inlet passage into the cavity.

2. The air filter housing of claim 1, wherein the entrance axis intersects the wall and defines an angle therebetween, with the angle being between 50 degrees and 70 degrees.

3. The air filter housing of claim 2, wherein the angle is between 55 degrees and 65 degrees.

4. The air filter housing of claim 1, wherein each of the teeth has a generally rectangular prismatic configuration and are spaced from one another within the row.

5. The air filter housing of claim 1, wherein the baffle comprises a frame extending at least partially across the inlet passage, with the teeth extending from the frame.

6. The air filter housing of claim 5, wherein the frame is positioned between the inlet passage and the outlet passage and is configured to deflect the air from the inlet passage through the teeth and into the cavity away from the outlet passage.

7. The air filter housing of claim 1, wherein the outlet passage extends along an exit axis through the wall into the cavity, with the exit axis transverse to the entrance axis.

8. The air filter housing of claim 7, wherein the wall of the body has a cylindrical configuration defining a first end portion and a second end portion spaced from one another along the exit axis and a central portion extending between the first end portion and the second end portion and around the exit axis.

9. The air filter housing of claim 8, wherein the inlet is disposed on the central portion of the wall and the outlet is disposed on the first end portion of the wall.

10. The air filter housing of claim 9, wherein the body has a midline halfway between the first end portion and the second end portion, with the inlet disposed between the first end portion and the midline.

11. The air filter housing of claim 9, wherein the baffle is connected to first end portion and extends from the first end portion toward the second end portion.

12. The air filter housing of claim 9, wherein the baffle extends at least partially around the exit axis.

13. The air filter housing of claim 9, further comprising a second baffle connected to the second end portion of the wall and extending from the second end portion toward the first end portion.

14. The air filter housing of claim 1, wherein at least a portion of the inlet is curved.

15. An air filter housing for a vehicle, the air filter housing comprising:
a body having a wall defining a cavity configured to retain an air filter therein, with the wall having a cylindrical configuration defining a first end portion and a second end portion spaced from one another along an exit axis and a central portion extending between the first end portion and the second end portion and around the exit axis;
an inlet defining an inlet passage in fluid communication with the cavity and configured to convey air into the cavity, wherein the inlet passage extends along an entrance axis through the central portion of the wall into the cavity, with the entrance axis transverse to the wall;
an outlet defining an outlet passage in fluid communication with the cavity and configured to convey the air out of the cavity, wherein the outlet passage extends along the exit axis through the first end portion of the wall into the cavity, with the exit axis transverse to the entrance axis; and
a baffle disposed within the cavity and connected to the first end portion, wherein the baffle extends from the first end portion toward the second end portion and is positioned adjacent the inlet passage, and wherein the baffle comprises teeth arranged in a row and positioned at least partially across the outlet passage to uniformly direct the air flowing from the inlet passage into the cavity,
wherein the entrance axis intersects the wall and defines an angle therebetween, with the angle being between 50 degrees and 70 degrees.

16. An air filtration system for a vehicle, the air filtration system comprising:
an air filter housing comprising:
a body having a wall defining a cavity;
an inlet defining an inlet passage in fluid communication with the cavity and configured to convey air into the cavity, wherein the inlet passage extends along an entrance axis through the wall into the cavity, with the entrance axis transverse to the wall;
an outlet defining an outlet passage in fluid communication with the cavity and configured to convey the air out of the cavity; and
a baffle disposed within the cavity and positioned adjacent the inlet passage, wherein the baffle comprises teeth arranged in a row and positioned at least partially across the outlet passage to uniformly direct the air flowing from the inlet passage into the cavity; and
an air filter disposed within the cavity and comprising a membrane positioned between the inlet and the outlet for removing debris from the air.

17. The air filtration system of claim 16, wherein the outlet passage extends along an exit axis through the wall into the cavity, with the exit axis transverse to the entrance axis.

18. The air filtration system of claim 17, wherein the wall of the body has a cylindrical configuration defining a first end portion and a second end portion spaced from one another along the exit axis and a central portion extending between the first end portion and the second end portion and around the exit axis.

19. The air filtration system of claim 18, wherein the membrane surrounds the exit axis such that the air filter has a cylindrical configuration corresponding to the body, with the membrane at least partially defining a bore that extends through the air filter along the exit axis.

20. The air filtration system of claim 19, wherein the membrane of the air filter is spaced from the central portion of the wall and divides the cavity into a first chamber disposed between the membrane and the central portion and a second chamber corresponding to the bore, with the air configured to permeate through the membrane from the first chamber to the second chamber.
